(19) United States
(12) Patent Application Publication
(10) Pub. No.: US 2005/0216721 A1
(43) Pub. Date: Sep. 29, 2005

(54) Methods and apparatus for initializing a memory

(76) Inventors: Vincent J. Zimmer, Federal Way, WA (US); Michael A. Rothman, Puyallup, WA (US)

Correspondence Address: GROSSMAN & FLIGHT LLC, Suite 4220, 20 North Wacker Drive, Chicago, IL, 60606-6357, US

(21) Appl. No.: 10/807,668

(22) Filed: Mar. 24, 2004

(51) Int. Cl. G06F 9/00

(52) U.S. Cl. 713/2

(57) ABSTRACT

Methods and apparatus for initializing a memory are disclosed. A disclosed system initializes a subset of memory and then loads an operating system. Subsets of a remaining memory are initialized during operating system idle periods. A notification for the operating system to dynamically incorporate the subsets of the remaining memory is created.

### TECHNICAL FIELD

The present disclosure pertains to memory associated with a processing unit and, more particularly, to methods and apparatus for initializing a memory.

### BACKGROUND

In general, computer systems such as servers and/or networks have a high expected availability (e.g., a high expectation that services provided by the computer system will be operable). For example, systems such as internet protocol telephony (IP telephony) servers have a high availability associated with the system because customers expect their telephone systems to be reliable and operational nearly 100% of the time. Metrics have been established to help qualify and/or quantify the availability of a server and/or a network. For example, a five nines metric (e.g., 99.999%) is a metric requiring systems to be available 99.999% of the time, which translates to less than 5.3 minutes of downtime in a year.

During a computer system's restart process (e.g., a boot process), memory in the computer system may need to be initialized to a known default state. For example, a computer system that uses error correction code (ECC) memory (e.g., a type of memory that includes a number of bits used to detect memory integrity), may set the initial state of ECC memory to be all logical zeros. As the amount of memory in the computer system increases, so too does an amount of time needed to serially initialize the ECC memory to the known default state. For example, a computer system with several gigabytes of ECC memory may require tens of seconds to initialize during a restart process.

The five nines metric limits the amount of downtime a computer system may have each year and, therefore, efforts have been made to reduce the time a computer system takes to reboot because reboot time is counted as downtime. One previous attempt to reduce downtime is to initialize the ECC memory devices in parallel (e.g., initialize all the ECC memory at one time). However, due to large amounts of memory found in many servers, parallel initialization of memory requires a large amount of electrical current that typical server power supplies may not satisfy.

### BRIEF DESCRIPTION OF THE DRAWINGS

FIG. 1 is a functional block diagram of an example system for initializing memory.

FIG. 2 is a flowchart representative of example machine readable instructions that may be executed to implement the example system of FIG. 1.

FIG. 3 a flowchart representative of example machine readable instructions that may be executed to implement the boot operating system process of FIG. 2.

FIG. 4 is a block diagram of an example processor system that may be used to implement the example methods and apparatus disclosed herein.

### DETAILED DESCRIPTION

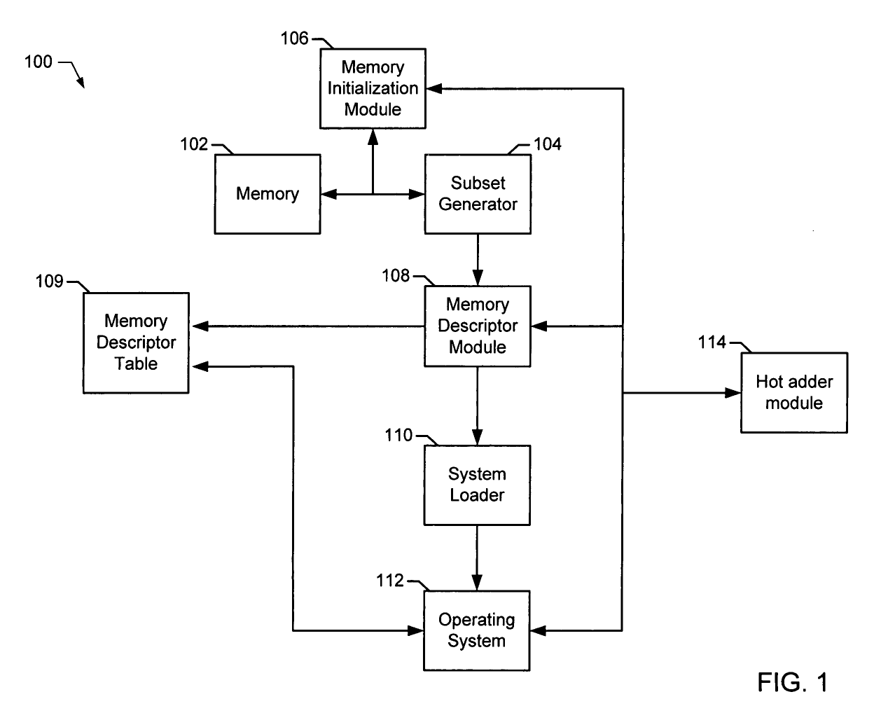

FIG. 1 is a block diagram of an example system 100 for initializing memory. In the example of FIG. 1, the example system 100 includes memory 102, a subset generator 104, a memory initialization module 106, a memory descriptor module 108, a memory descriptor table 109, a system loader 110, an operating system 112, and a hot adder module 114. The example system 100 may be implemented as several components of hardware, each of which is configured to perform one or more functions, may be implemented in software where one or more software and/or firmware programs are used to perform the different functions, or may be a combination of hardware and software. A person of ordinary skill in the art will readily appreciate that the subset generator 104, the memory initialization module 106, the memory descriptor module 108, the system loader 110, the operating system 112, and the hot adder module 114 may be implemented in hardware and/or software but the memory 102 and the memory descriptor table 109 are typically hardware constructs.

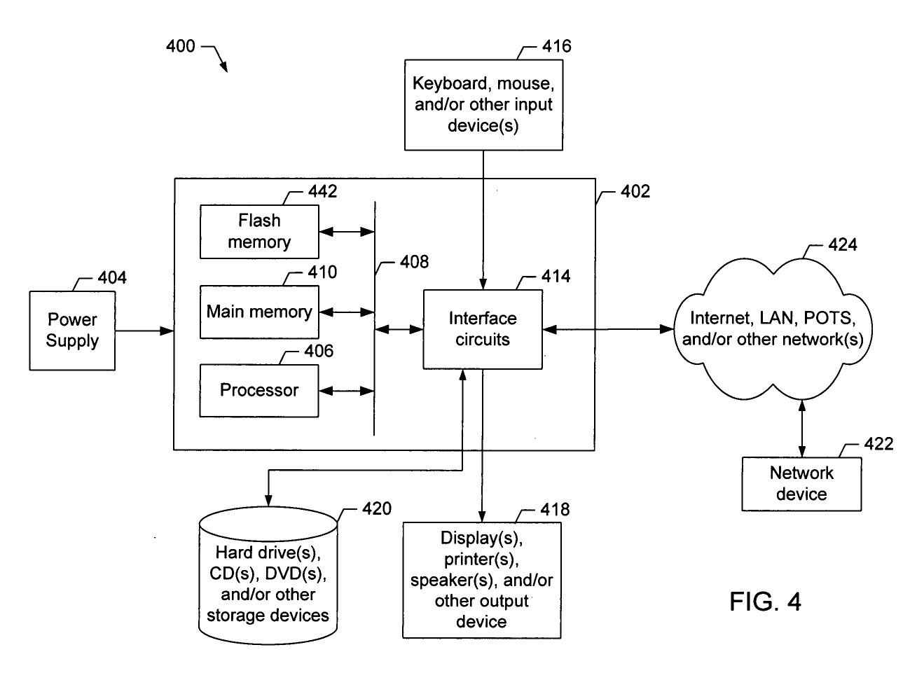

The memory 102 may be any type of random access memory similar to the main memory device 410 (FIG. 4) and is described in more detail in connection with FIG. 4. The memory 102 may also be ECC memory that may use parity syndrome bits to detect a data corruption in the ECC memory. The ECC memory is well known to a person of ordinary skill in the art and is not described herein.

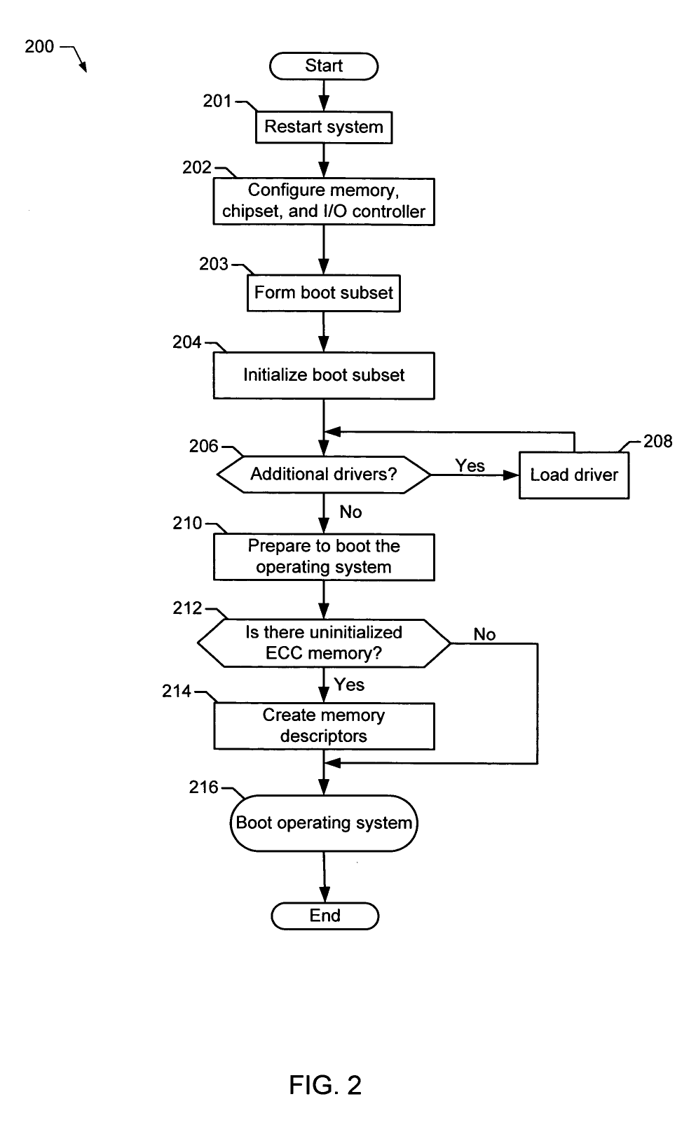

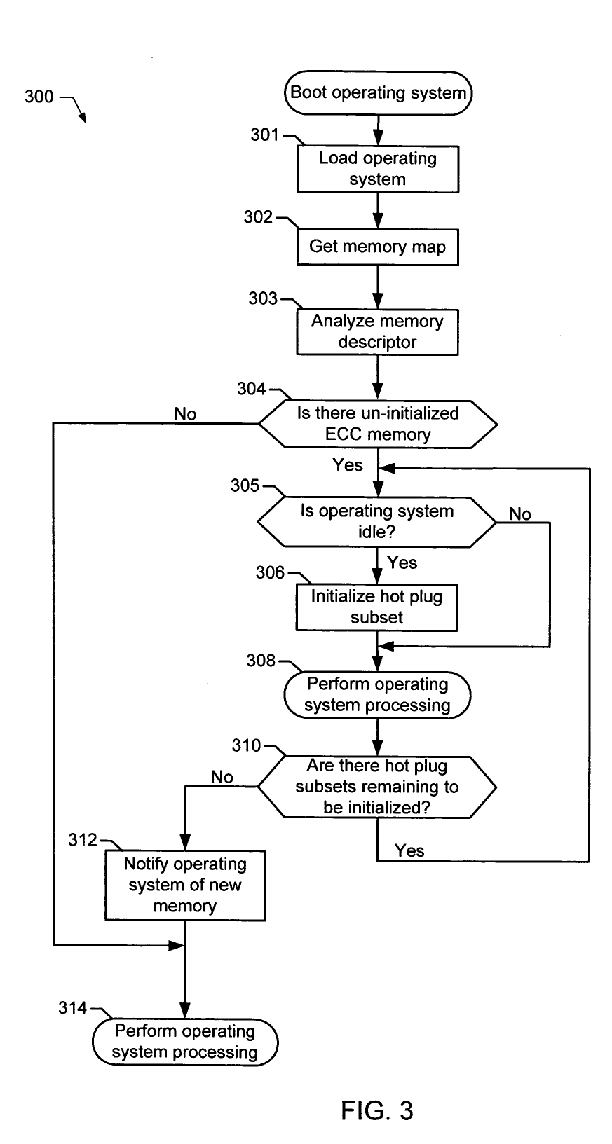

The subset generator 104 may be configured to select a subset of memory locations and/or addresses (e.g., a boot subset) from the memory 102. The boot subset is a subset of memory to be initialized during the boot process. The boot subset may be a minimum amount of memory required for execution of the operating system 112 or may be an amount greater than the minimum amount of memory required by the operating system 112. The subset generator 104 may also be configured to divide the remaining memory (e.g., the memory remaining after the boot subset has been selected) into subsets (e.g., hot plug subsets) that are initialized after the operating system 112 has been loaded. As described below in conjunction with FIGS. 2 and 3, the subset generator 104 may divide the remaining memory into hot plug subsets as a background task either before or after the operating system 112 has been loaded. The hot plug subsets may be selected such that the hot plug subsets have a predetermined size, which may be a percentage of the remaining memory and/or may be chosen such that the initialization of each individual hot plug subset is performed in a short period of time. The size of the hot plug subset may be determined by software and/or by user input after considering the above factors.

The memory initialization module 106 may be configured to initialize a subset of memory selected by the subset generator 104 (e.g., a boot subset, one or more hot plug subsets, and/or any other subset of memory) to a known default state. For example, the memory initialization module 106 may write logical zeroes to the memory locations within the subset of memory (e.g., may clear the subset of memory). Alternatively, the memory initialization module 106 may write logical ones to memory locations within the subset of memory. A person of ordinary skill in the art will readily appreciate that the subsets of memory may be initialized to any known default state that may be chosen by software, a user input, and/or the type of memory to be initialized. The memory initialization module 106 may also be configured to access a memory map and/or to store a copy of the memory map. The memory initialization module 106 may also be configured to access memory descriptors generated by the memory descriptor module 108, which is described below. The memory initialization module 106 may also be configured to determine if, and/or be instructed, that the operating system 112 is in an idle period (e.g., a period of time where an insignificant amount of computation and/or system processing is occurring). An idle period of the operating system 112 may be detected by monitoring a power state of a processor 406 (FIG. 4) and/or an amount of processing load on the processor 406. The memory initialization module 106 may also detect when a hot plug subset and/or a plurality of hot plug subsets have been initialized and provide an indication (e.g., a hot adder indication) to the hot adder module 114.

The memory descriptor module 108 may be configured to generate and/or modify memory descriptors in a data structure (e.g., the memory descriptor table 109) that indicate the presence of un-initialized memory (e.g., the hot plug subsets). For example, in an extensible firmware interface (EFI) system, the memory descriptor module 108 may update the memory descriptor table 109 with a unique string of bits (e.g., a GUID) that is accessible by a function call from the operating system 112 to indicate the presence of the hot plug subsets. A person of ordinary skill in the art will readily appreciate that there are many methods to generate and/or modify the memory descriptor table 109 and allow the operating system 112 to access the memory descriptor table 109.

The memory descriptor table 109 may be a data structure configured to store memory descriptors. The memory descriptors may be generated and/or modified by the memory descriptor module 108, as described above, and may include information associated with the memory 102 such as the address/location of memory, types of memory, size of memory, number of hot plug subsets, etc. The memory descriptor table 109 is also configured to report the memory descriptors to the operating system 112 and/or the memory initialization module 108. An example memory descriptor table 109 is the Advanced Configuration and Power Interface (ACPI) table.

The system loader 110 is configured to load the operating system 112. The system loader 110 may be configured to prepare the example system 100 to invoke the operating system 112. For example, the system loader 110 may prepare stack space, initiate an operating system kernel, create a memory map, etc. The system loader 110 is well known to a person of ordinary skill in the art and is not further describe here.

The operating system 112 is any operating system known in the art. The operating system 112, which is a software construct operating on hardware, may have idle periods. The operating system 112 may also be configured to analyze the memory descriptors created and/or modified by the memory descriptor module 108 to determine if any memory needs to be initialized (e.g., if hot plug subsets exist). The operating system 112 may also be configured to determine a memory map associated with the computer system and update the memory map when new memory is detected. For example, the operating system 112 may determine the memory map by making an EFI memory map function call and/or use an E820 memory detection scheme. In addition, the operating system 112 may receive a notification that new memory is available to be added and the operating system 112 may append the new memory to the memory map so that the new memory is usable by the operating system 112 and the computer system.

The hot adder module 114 is configured to generate a notification to the operating system 112 to dynamically incorporate initialized memory (e.g., a hot plug event). The hot adder module 114 may generate the notification after the hot adder indication is received from the memory initialization module 106. The memory to be dynamically incorporated may be one or more hot plug subsets and/or may be any other memory. The hot adder module 114 may implement the notification using different methods such as a software interrupt, an operating system event, and/or any other method to transmit a message to the operating system 112.

FIGS. 2 and 3 are flowcharts depicting an example manner in which memory may be initialized. The illustrated processes 200 and 300 may be implemented using one or more software and/or firmware programs that are stored in one or more memories (e.g., the flash memory 412 and/or the hard disk 420 of FIG. 4) and executed by one or more processors (e.g., the processor 406 of FIG. 4) in a well-known manner. However, some or all of the blocks of the processes 200 and 300 may be performed manually and/or by some other device. Although the processes 200 and 300 are described with reference to the flowcharts illustrated in FIGS. 2 and 3, a person of ordinary skill in the art will readily appreciate that many other methods of performing the processes 200 and 300 may be used. For example, the order of the blocks may be altered, the operation of one or more blocks may be changed, blocks may be combined, and/or blocks may be eliminated. FIGS. 2 and 3 are described below in conjunction with the memory 102 of FIG. 1.

The example process 200 may be firmware and/or software instructions that are executed before an operating system is loaded. In one example, the instructions representing the functionality of the example process 200 are stored in a non-volatile memory such as a flash memory device 412 of FIG. 4. The example process 200 begins by restarting a computer system (e.g., a server) (block 201). As the computer system is restarting, a computer's chipset and input/output (I/O) controller are initialized (block 202). In addition, memory (e.g., the memory 102 of FIG. 1), and the associated memory controller are configured (e.g., a memory controller is initialized such that configuration registers that define memory characteristics such as refresh rates are set) (block 202).

After the memory controller has been configured (block 202), a subset of ECC memory (e.g., a boot subset) is selected from the memory (block 203). The boot subset may be a portion of memory large enough to satisfy an operating system's minimum requirements. For example, if an operating system requires 64 megabytes (MB) of memory for operation, the boot subset is at least 64 MB in size. After the boot subset is formed (block 203), the boot subset is initialized to a known default state (block 204). For example, all the memory locations within the boot subset may be initialized to be all logical zeros.

After the boot subset is initialized, the process 200 determines if hardware drivers, such as display drivers, sound card drivers, etc., need to be loaded (block 206). If drivers need to be loaded (block 206), the driver is loaded (block 208) and control returns to block 206. A person of ordinary skill in the art will readily appreciate that the loading of drivers is well known in the art and is not described herein. Otherwise, the process 200 prepares to boot the operating system (block 210). Preparation to boot the operating system may include detecting an operating system boot loader and/or creating a memory map, etc. The memory map may be copied to a location that is accessible to a memory initialization module and/or accessible by other hardware or processes or parts of processes.

The process 200 continues by determining if any un-initialized ECC memory exists (block 212). If there is not any un-initialized ECC memory (block 212), the operating system may be booted (block 216). For example, if the minimum requirement of the operating system is equal to the total amount of ECC memory, there will not be any un-initialized ECC memory. However, if un-initialized ECC memory exists (block 212), a set of memory descriptors is generated (block 214). The set of memory descriptors may be included in a data structure stored in memory that describes the state of various portions of memory and may be stored in a descriptor table (e.g., the memory descriptor table 109 of FIG. 1) located in memory. For example, the set of memory descriptors may describe the un-initialized ECC memory and/or may describe subsets of the un-initialized ECC memory. After the set of memory descriptors are generated and stored in memory (block 214), the process 200 boots the operating system by calling a boot operating system process (block 216).

One example boot operating process 300, which may be used to implement block 216 of FIG. 2 is shown in FIG. 3. The process 300 begins by loading the operating system (block 301). The operating system may be loaded by invoking an operating system loader, starting the operating system kernel, etc. A person of ordinary skill in the art will readily appreciate that loading an operating system is well known in the art and is not further described here.

The process 300 continues by determining a memory map of the computer system (block 302) which may be carried out using a software function call (e.g., an EFI function to determine the memory map) and/or a memory detection scheme such as the E820 memory detection algorithm. The process 300 also accesses the memory descriptors generated in block 214 of FIG. 2 and analyzes the memory descriptors to determine if there are subsets of memory to be initialized (block 303). The process 300 may use a software function to access the memory descriptor table or may directly access the memory descriptor table. The memory map and the memory descriptors may be accessed by the operating system and/or the memory initialization module.

After the memory map is determined (block 302) and the memory descriptors have been analyzed (block 303), the process 300 determines if there is any un-initialized ECC memory (block 304). The process 300 may inspect memory descriptors created in block 214 of FIG. 2 to determine if un-initialized ECC memory exists.

If un-initialized memory does not exist (block 304), the process 300 advances to block 314 and operating system processing is performed (block 314). The operating system may process typical operating system tasks such as processing user inputs (e.g., keyboard inputs, inputs from a mouse, etc.), updating a display, generating sounds, and/or executing any type of instruction or calculation requested by an application and/or a system resource. If the process 300 determines un-initialized ECC memory exists (block 304), the process 300 determines if the operating system is in an idle period (block 305). The idle periods may be detected by monitoring a processor for low power states and/or measuring the amount of processing load on the processor. If the operating system is not idle (block 305), control advances to block 308 and operating system processing is performed. The operating system processing may be similar to the processing performed in block 314 and may include typical operating system tasks such as processing keyboard inputs, updating a display, processing software interrupts, and/or executing any instruction or calculation requested by an application and/or a software resource.

If the operating system is idle (block 305), the process 300 initializes a subset of the un-initialized ECC memory (e.g., a hot plug subset created by the subset generator) (block 306). The hot plug subset may be a small percentage of the un-initialized ECC memory so that the initialization of the hot plug subset may be completed during the operating system's idle period. After the hot plug subset is initialized (block 306), operating system processing, similar to block 314, is performed (block 308).

After the operating system finishes processing instructions and/or calculations (block 308), the process 300 determines if any hot plug subsets remain to be initialized (block 310). If hot plug subsets remain to be initialized (block 310), control returns to block 305. Otherwise, a notification is created to inform the operating system of the presence of new memory to be incorporated into the memory map (block 312). The notification may be a hot plug event or any other event recognized by the operating system to add memory to the memory map. The notification is received by the operating system 112 and the hot plug subsets are dynamically incorporated. The process 300 then performs operating system processing as described above (block 314).

FIG. 4 is a block diagram of an example computer system illustrating an environment of use for the disclosed system. The computer system 400 may be a personal computer (PC) or any other computing device. In the example illustrated, the computer system 400 includes a main processing unit 402 powered by a power supply 404. The main processing unit 402 may include a processor 406 electrically coupled by a system interconnect 408 to a main memory device 410, a flash memory device 412, and one or more interface circuits 414. In an example, the system interconnect 408 is an address/data bus. Of course, a person of ordinary skill in the art will readily appreciate that interconnects other than busses may be used to connect the processor 406 to the other devices 410, 412, and/or 414. For example, one or more dedicated lines and/or a crossbar may be used to connect the processor 406 to the other devices 410, 412, and/or 414.

The processor 406 may be any type of processor, such as a processor from the Intel Pentium® family of microprocessors, the Intel Itanium® family of microprocessors, the Intel Centrino® family of microprocessors, and/or the Intel XScale® family of microprocessors. In addition, the processor 406 may include any type of cache memory, such as static random access memory (SRAM). The main memory device 410 may include dynamic random access memory (DRAM) and/or any other form of random access memory. For example, the main memory device 410 may include double data rate random access memory (DDRAM). The main memory device 410 may also include non-volatile memory. In an example, the main memory device 410 stores a software program which is executed by the processor 406. The flash memory device 412 may be any type of flash memory device. The flash memory device 412 may store firmware used to boot the computer system 400.

The interface circuit(s) 414 may be implemented using any type of interface standard, such as an Ethernet interface and/or a Universal Serial Bus (USB) interface. One or more input devices 416 may be connected to the interface circuits 414 for entering data and commands into the main processing unit 402. For example, an input device 416 may be a keyboard, mouse, touch screen, track pad, track ball, isopoint, and/or a voice recognition system.

One or more displays, printers, speakers, and/or other output devices 418 may also be connected to the main processing unit 402 via one or more of the interface circuits 414. The display 418 may be a cathode ray tube (CRT), a liquid crystal display (LCD), or any other type of display. The display 418 may generate visual indications of data generated during operation of the main processing unit 402. The visual indications may include prompts for human operator input, calculated values, detected data, etc.

The computer system 400 may also include one or more storage devices 420. For example, the computer system 400 may include one or more hard drives, a compact disk (CD) drive, a digital versatile disk drive (DVD), and/or other computer audio input/output (I/O) devices.

The computer system 400 may also exchange data with other devices 422 via a connection to a network 424. The network connection may be any type of network connection, such as an Ethernet connection, digital subscriber line (DSL), telephone line, coaxial cable, etc. The network 424 may be any type of network, such as the Internet, a telephone network, a cable network, and/or a wireless network. The network devices 422 may be any type of network devices 422. For example, the network device 422 may be a client, a server, a hard drive, etc.

Although the following discloses example systems, including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the description above describes example systems, persons of ordinary skill in the art will readily appreciate that the examples are not the only way to implement such systems.

In addition, although certain methods, apparatus, and articles of manufacture have been described herein, the scope of coverage of this patent is not limited thereto. On the contrary, this patent covers all apparatus, methods and articles of manufacture fairly falling within the scope of the appended claims either literally or under the doctrine of equivalents.

1. A method comprising:
initializing a subset of a memory;
loading an operating system;
initializing subsets of a remaining memory during operating system idle periods; and
creating a notification for the operating system to dynamically incorporate the subsets of the remaining memory.

2. A method as defined in claim 1, wherein the memory is error correction control memory.

3. A method as defined in claim 1, wherein initializing the subset of the memory comprises setting the subset of the memory to a default state.

4. A method as defined in claim 1, wherein the notification for the operating system to dynamically incorporate the subsets of the remaining memory comprises a hot plug event.

5. A method as defined in claim 1, wherein the subsets of the remaining memory are dynamically incorporated by updating a memory map.

6. A method as defined in claim 1, further comprising:
creating a memory descriptor for the subsets of the remaining memory before loading the operating system;
determining the memory map; and
analyzing the memory descriptor to determine a presence of the subsets of the remaining memory to be initialized.

7. A method comprising:
initializing a subset of a memory;
creating a memory descriptor for subsets of a remaining memory; and
loading an operating system;

8. A method as defined in claim 7, wherein the memory is error correction control memory.

9. A method as defined in claim 7, wherein initializing the subset of the memory comprises setting the subset of the memory to a default state.

10. A method as defined in claim 7, wherein the subset of the memory is of a size at least as large as a minimum requirement associated with the operating system.

11. A method comprising:
determining a memory map;
analyzing a memory descriptor to determine a presence of the subsets of the remaining memory to be initialized;
initializing subsets of the remaining memory during operating system idle periods; and
creating a notification for the operating system to dynamically incorporate the subsets of the remaining memory.

12. A method as defined in claim 11, wherein initializing the subsets of the remaining memory during operating system idle periods comprises setting the subsets of the remaining memory to a default state.

13. A method as defined in claim 11, wherein the notification for the operating system to dynamically incorporate the subsets of the remaining memory comprises a hot plug event.

14. A method as defined in claim 11, wherein the memory descriptor comprises at least one of a data structure and an entry in a table.

15. A method as defined in claim 11, wherein the subsets of the remaining memory are dynamically incorporated by updating the memory map.

16. An apparatus comprising:
a memory initialization module configured to initialize a subset of a memory;
a system loader configured to load an operating system; and
a hot adder module configured to create a notification for the operating system to dynamically incorporate subsets of a remaining memory.

17. An apparatus as defined in claim 16, wherein the memory initialization module is configured to set the subset of the memory to a default state.

18. An apparatus as defined in claim 16, wherein the memory initialization module is configured to set the subsets of the remaining memory to the default state during operating system idle periods.

19. An apparatus as defined in claim 16, wherein the notification for the operating system to dynamically incorporate the subsets of the remaining memory comprises a hot plug event.

20. An apparatus as defined in claim 16, wherein the subsets of the remaining memory are dynamically incorporated by updating a memory map.

21. An apparatus as defined in claim 16, further comprising:
a subset generator configured to create the subsets of the remaining memory; and
a memory descriptor module configured to generate a data structure to indicate a presence of the subsets of the remaining memory.

22. An article of manufacture having instructions stored thereon that, when executed, cause a machine to:
initialize a subset of a memory;
load an operating system;
initialize subsets of a remaining memory during operating system idle periods; and
create a notification for the operating system to dynamically incorporate the subsets of the remaining memory.

23. An article of manufacture as defined in claim 22 having instructions stored thereon that, when executed, cause the machine to initialize the subset of the memory by setting the subset of memory to a default state.

24. An article of manufacture as defined in claim 22 having instructions stored thereon that, when executed, cause the machine to initialize the subsets of the remaining memory during operating system idles by setting the subsets of the remaining memory to a default state.

25. An article of manufacture as defined in claim 22 having instructions stored thereon that, when executed, cause the machine to update a memory map to dynamically incorporate the subsets of the remaining memory.

26. An article of manufacture as defined in claim 22 having instructions stored thereon that, when executed, cause the machine to:
create a memory descriptor for the subsets of the remaining memory before loading the operating system;
determine the memory map; and
analyze the memory descriptors to determine a presence of the subsets of the remaining memory to be initialized.

27. An apparatus comprising:
a memory initialization module configured to initialize a subset of a memory;
a subset generator configured to create the subsets of the remaining memory;
a memory descriptor module configured to generate a data structure to indicate a presence of the subsets of the remaining memory; and
a system loader configured to load an operating system.

28. An apparatus as defined in claim 27, wherein the memory initialization module is configured to set the subset of the memory to a default state.

29. An apparatus comprising:
an operating system;
a memory initialization module configured to initialize subsets of a memory; and
a hot adder module configured to create a notification for the operating system to dynamically incorporate subsets of the memory.

30. An apparatus as defined in claim 29, wherein the memory initialization module is configured to set subsets of the memory to a default state.

31. An apparatus as defined in claim 29, wherein the notification for the operating system to dynamically incorporate the subsets of the memory comprises a hot plug event.

32. An apparatus as defined in claim 29, wherein the subsets of the remaining memory are dynamically incorporated by updating a memory map.

33. An apparatus as defined in claim 29, wherein the memory initialization module is configured to set the subsets of the remaining memory to the default state during operating system idle periods.

34. An article of manufacture having instructions stored thereon that, when executed, cause a machine to:
initialize a subset of a memory;
create a memory descriptor for subsets of a remaining memory; and
load an operating system;

35. An article of manufacture as defined in claim 34 having instructions stored thereon that, when executed, cause the machine to initialize the subset of the memory by setting the subset of the memory to a default state.

36. An article of manufacture as defined in claim 35 having instructions stored thereon that, when executed, cause the machine to create a memory descriptor by updating at least one of a data structure and a table.

37. An article of manufacture having instructions stored thereon that, when executed, cause a machine to:
determine a memory map;
analyze a memory descriptor to determine a presence of the subsets of a remaining memory to be initialized;
initialize the subsets of the remaining memory during operating system idle periods; and
create a notification for the operating system to dynamically incorporate the subsets of the remaining memory.

38. An article of manufacture as defined in claim 37 having instructions stored thereon that, when executed, cause the machine to initialize the subsets of the remaining memory during operating system idle periods by setting the subsets of the remaining memory to a default state.

39. An article of manufacture as defined in claim 37 having instructions stored thereon that, when executed, cause the machine to create the notification for the operating system to dynamically incorporate the subsets of the remaining memory by creating a hot plug event.

40. An article of manufacture as defined in claim 37 having instructions stored thereon that, when executed, cause the machine to dynamically incorporated by updating the memory map.
